(19) United States
(12) Patent Application Publication
(10) Pub. No.: US 2025/0134337 A1
(43) Pub. Date: May 1, 2025

(54) BODY FOR A SQUEEGEE OR WIPER, SQUEEGEE AND WIPER, AND METHOD FOR SQUEEGEEING OR WIPING A SURFACE

(71) Applicant: BRANDIVISION GMBH, Düsseldorf (DE)

(72) Inventor: Timo USTER, Hohen Neuendorf (DE)

(21) Appl. No.: 18/834,806

(22) PCT Filed: Dec. 21, 2022
(86) PCT No.: PCT/DE2022/100973

§ 371 Date: Jul. 31, 2024

(30) Foreign Application Priority Data
Feb. 3, 2022 (DE) 10 2022 102 595.0

(51) Int. Cl. A47L 13/11; A47L 1/06; B25G 1/04

(52) U.S. Cl. CPC A47L 13/11; A47L 1/06; B25G 1/04

(57) ABSTRACT

A body for a squeegee or wiper, a squeegee and a wiper as well as a method for squeegeeing or wiping a surface. A swivel joint is arranged between the handle and the head section of corresponding devices. This is combined with a telescopic handle, whereby the swivel joint and the telescopic handle complement each other synergistically.

The invention relates to a body for a squeegee or wiper, as well as a squeegee and a wiper with a corresponding body.

Furthermore, the invention relates to a method for squeegeeing or wiping a surface using a squeegee or a wiper.

Squeegees are used to wipe smooth surfaces such as windows or shower walls.

Known squeegees have a head section with a squeegee lip that is aligned transversely to a handle connected to the head section. The squeegee lip forms a sharp edge and must be pulled at a flat angle over a smooth surface in order to mechanically remove the moisture adhering to the surface by the squeegee. For optimum results, the angle of attack and the pressure of the squeegee lip on the surface must be kept as constant as possible during the squeegee operation.

Squeegeeing is often carried out by squeegeeing the wet surface vertically from top to bottom in roughly parallel strips, depending on the width of the surface.

When using known squeegees to remove water droplets from a glass wall, for example, various problems arise. If the lower part of the wall is to be squeegeed, the user of the squeegee must change from a standing to a bent and/or squatting position. The angle of attack of the pressure of the squeegee lip on the surface cannot be kept constant during use due to the constantly changing hand and arm position. This is almost impossible, especially for people with limited mobility.

The rigid design of conventional squeegees requires an uncomfortable body and arm posture to achieve an acceptable result, as the alignment of the squeegee lip and the exertion of the required pressure force at any height must be achieved by adjusting the body and arm posture accordingly.

It is therefore an object of the invention to create an improved body for a squeegee.

According to the invention, this object is achieved by a body for a squeegee according to patent claim 1.

It is a further object of the invention to create an improved squeegee and an improved wiper.

According to the invention, these objects are achieved by a squeegee according to patent claim 11 and a wiper according to patent claim 12.

Furthermore, it is an object of the invention to provide an improved method for squeegeeing or wiping a surface.

According to the invention, this object is achieved by a method for squeegeeing or wiping a surface according to claim 13.

Advantageous embodiments of the invention are claimed in the dependent patent claims.

The following disclosed features of a body for a squeegee, a squeegee and a wiper are part of the invention in all practicable combinations.

A body for a squeegee according to the invention has a handle and a head section connected to the handle. A squeegee lip is arranged on the head section transversely to the longitudinal direction of the handle.

In embodiments of the invention, the squeegee lip is made of rubber.

Furthermore, the head section is connected to the handle via a swivel joint so that the head section can be rotated about an axis parallel to the squeegee lip. The swivel joint is spring-loaded to allow the required pressure of the squeegee lip on the surface to be squeegeed.

In embodiments of the invention, the suspension of the swivel joint is realized by a torsion spring.

The use of a swivel joint makes it possible for a user at different heights and in particular also in an area below the center of the body to perform the squeegeeing operation in a comfortable posture, as the required angle of attack of the squeegee lip on the surface to be squeegeed can be kept constant when the angle between the handle and the head section of the squeegee is varied. The orientation of the squeegee lip is thus partially decoupled from the orientation of the handle by the swivel joint.

In embodiments of the invention, the swivel joint can be locked so that the angle from the head section to the handle is fixed in the locked position.

In embodiments of the invention, the head section is pivotable relative to the handle in an angular range of approximately 190°.

In preferred embodiments of the invention, at least one sliding or rolling device different from the squeegee lip is arranged on the head section. The sliding or rolling device is arranged in front of the squeegee lip in the wiping direction and has at least one contact surface for contacting the surface to be squeegeed.

When pressed against the surface to be squeegeed, the sliding or rolling device, together with the spring-loading of the swivel joint, ensures that the pressure force and the angle of attack of the squeegee lip on the surface to be squeegeed is kept constant.

In preferred embodiments, several sliding or rolling devices are arranged on the head section, which are arranged approximately parallel to the squeegee lip in the longitudinal direction of the latter. Rollers naturally have an axis of rotation parallel to the squeegee lip so that they roll on the surface to be squeegeed during a linear wiping movement.

The body for a squeegee according to the invention can be pressed with the at least one contact surface against the surface to be squeegeed.

In particularly preferred embodiments of the invention, the handle is telescopic, so that areas of a surface to be squeegeed that are further away can be reached both upwards and downwards from a comfortable body position.

In particularly preferred embodiments of the invention, the telescoping capability of the handle is coupled to the alignment and movement of the body for a squeegee in such a way that the handle is automatically telescopable when the body for a squeegee is moved along a surface to be squeegeed with the aid of at least one drive element.

As a result, the handle extends automatically in a predetermined area when a surface to be squeegeed is being squeegeed, so that the user can always maintain a comfortable posture.

In other embodiments, the telescoping of the handle is motorized. The motor for telescoping the handle can be integrated automatically and/or manually controllable.

In particularly preferred embodiments, the body is designed in such a way that the telescoping mechanism of the handle is automatically activated when the head section and handle are at an angle of approximately 90° to each other. With a vertical orientation of the working direction, this corresponds approximately to the position in which the handle is aligned approximately horizontally.

A squeegee according to the invention has a body for a squeegee according to the invention.

In accordance with the invention, the technical teaching can also be applied analogously to a wiper which has a wiper bar instead of the squeegee lip or in addition to the squeegee lip.

In embodiments of the invention, the wiping bar is made of an absorbent, soft material or material mix.

Accordingly, a wiper according to the invention also has a body according to the invention as described above.

In further embodiments of the invention, the handle is designed to be telescopic without a swivel joint being arranged between the handle and the head section. The various disclosed embodiments of the telescopic handle are used in these embodiments.

A method according to the invention for squeegeeing or wiping a surface is carried out using a squeegee or wiper according to the invention.

The wiper or squeegee is positioned with its wiper bar or squeegee lip at a first position on the surface to be wiped or squeegeed.

In embodiments of the invention in which wiping or squeegeeing of the surface is carried out from top to bottom, this first position is the highest position in the sense of the highest point of the surface to be wiped or squeegeed.

The squeegee or wiper is then guided along the surface in one direction.

If the method is used on surfaces that come into contact with a second surface oriented at an angle to the surface to be wiped or squeegeed, such as the floor or a window frame, in the end area of the wiping or squeegeeing movement, the squeegee or wiper is moved away from the surface to be wiped or squeegeed along this second surface after contacting this second surface until the end area of the surface to be wiped or squeegeed is also wiped or squeegeed by the wiping bar of the wiper or the squeegeeing lip of the squeegee by tilting the head section of the wiper or squeegee.

The teaching according to the invention makes it possible to simplify the use of the objects according to the invention, to save time during use, to improve the result, to reduce the physical strain on the user and to reduce the risk of accidents during use.

Exemplary embodiments of the invention are shown in the figures explained below. They show:

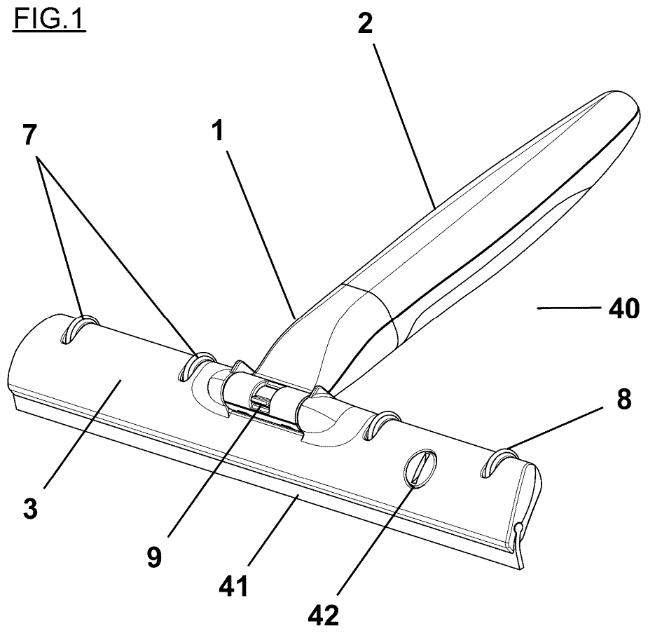

FIG. 1: A perspective view of a first embodiment of a squeegee with a body according to the invention,

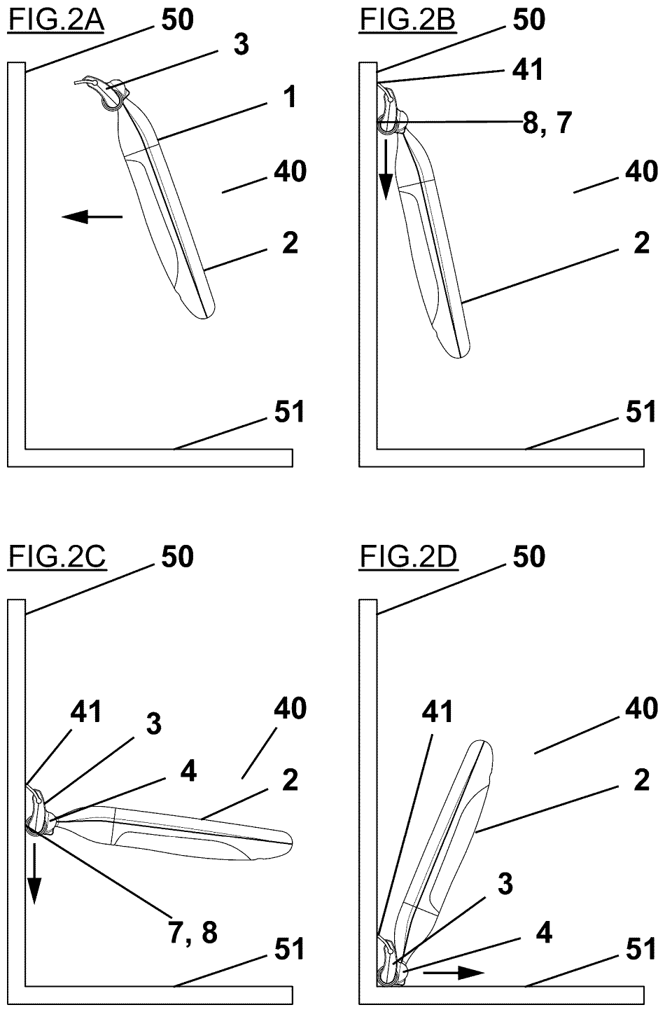

FIGS. 2A-2D: Side views of the embodiment shown in FIG. 1 in various positions of the head section,

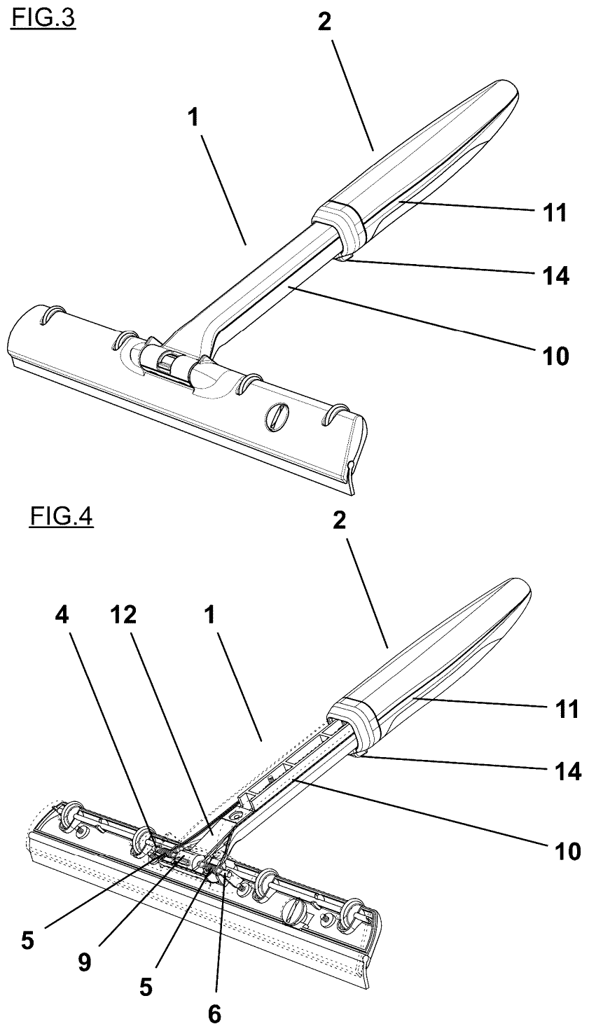

FIG. 3: A perspective view of an embodiment of a squeegee with telescopic handle,

FIG. 4: An illustration of the embodiment in FIG. 3 with the housing partially open,

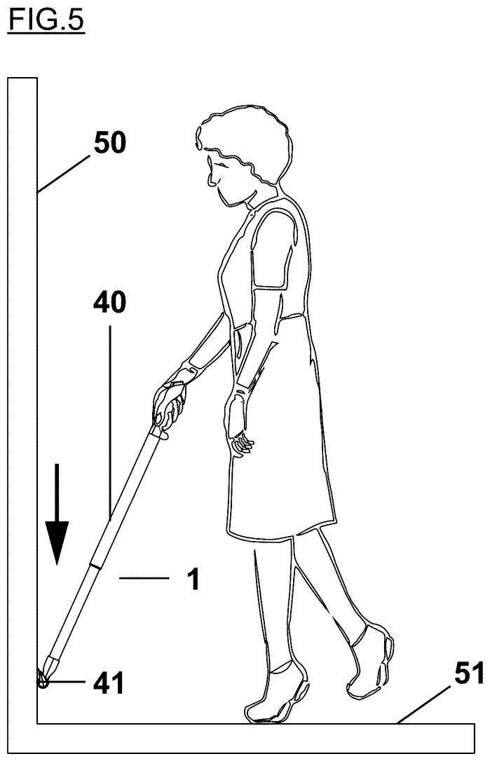

FIG. 5: A schematic representation of a squeegee according to the invention in use,

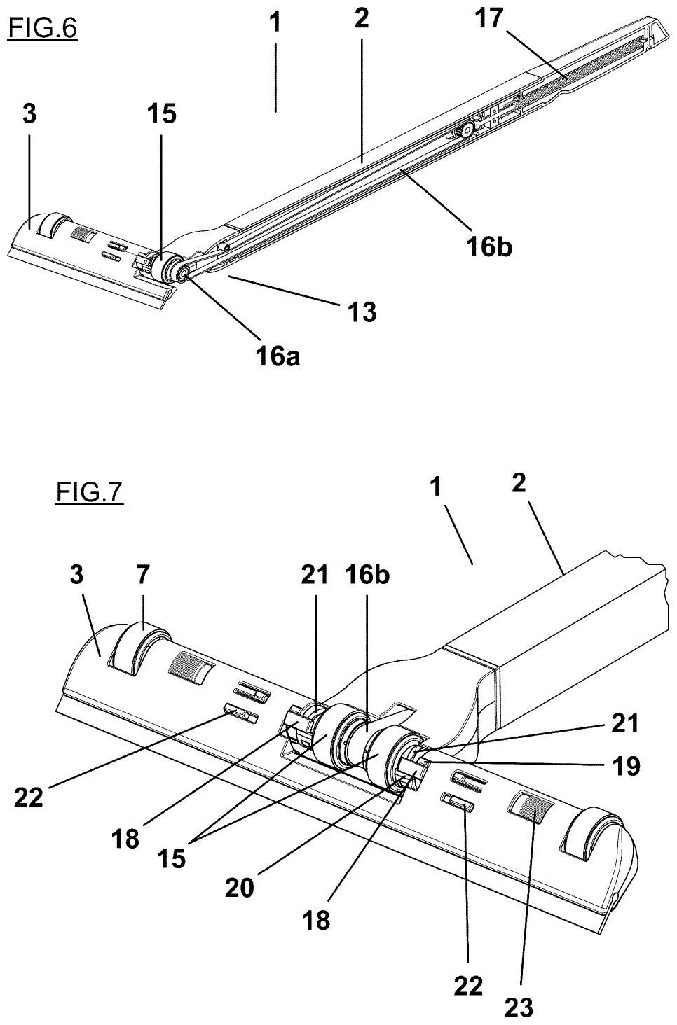

FIG. 6: A sectional view of an embodiment with telescopic handle and drive,

FIG. 7: A detailed view of an embodiment according to FIG. 6 in the area of the head section,

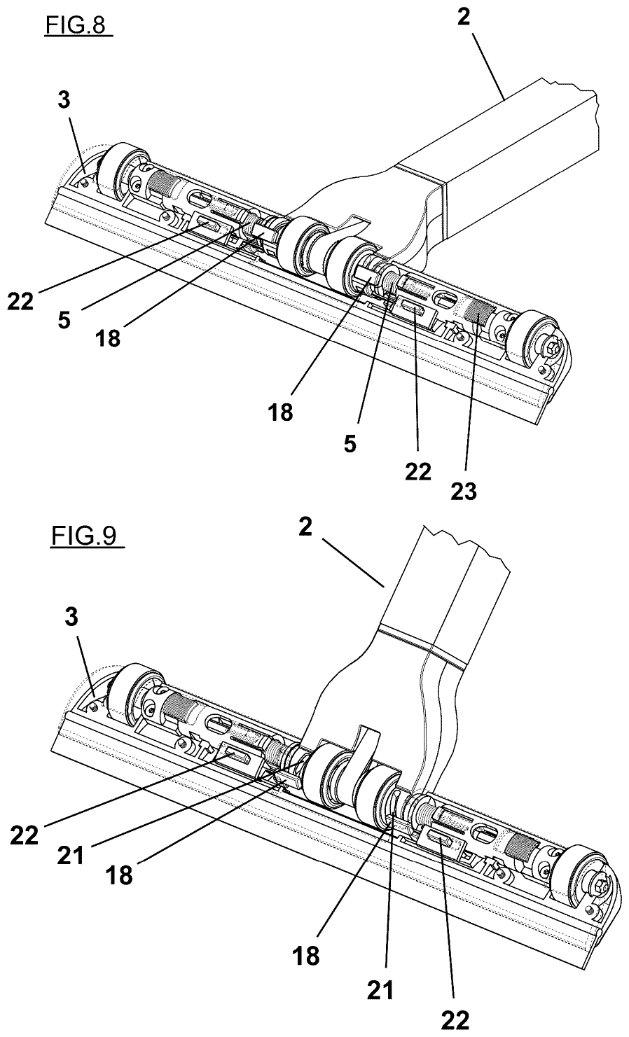

FIG. 8: The view shown in FIG. 7 with the housing partially open,

FIG. 9: A view of the embodiment in FIG. 8 with a different angle of the handle to the head section,

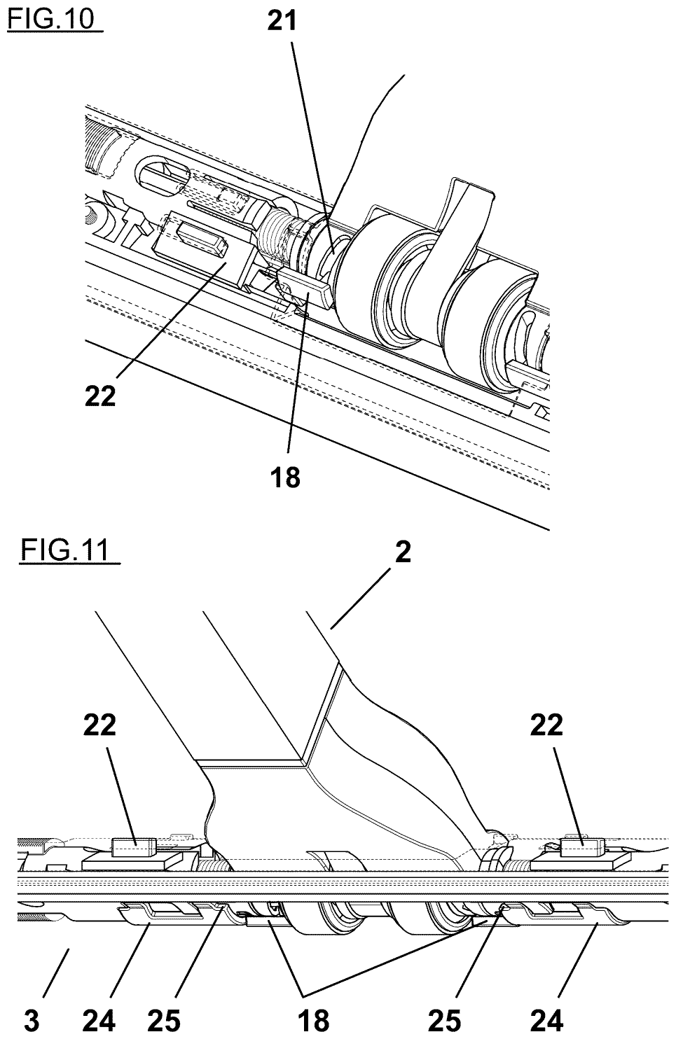

FIG. 10: A detailed view in the area of the drive of the telescoping mechanism,

FIG. 11: A rear view of the head section of the embodiment shown in FIGS. 6 to 10,

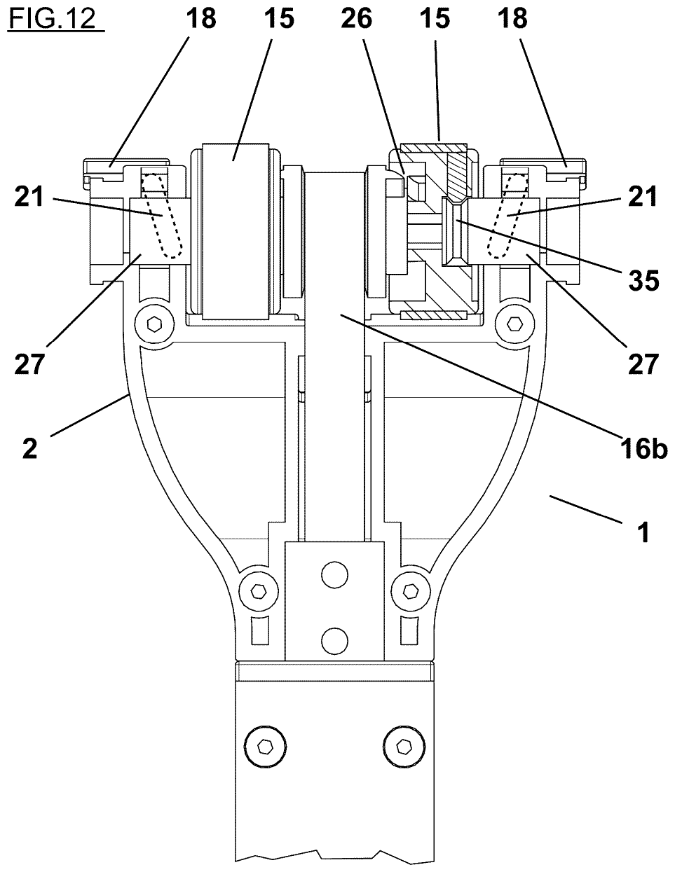

FIG. 12: A detailed view of the construction in the area of the drive element of the telescoping mechanism,

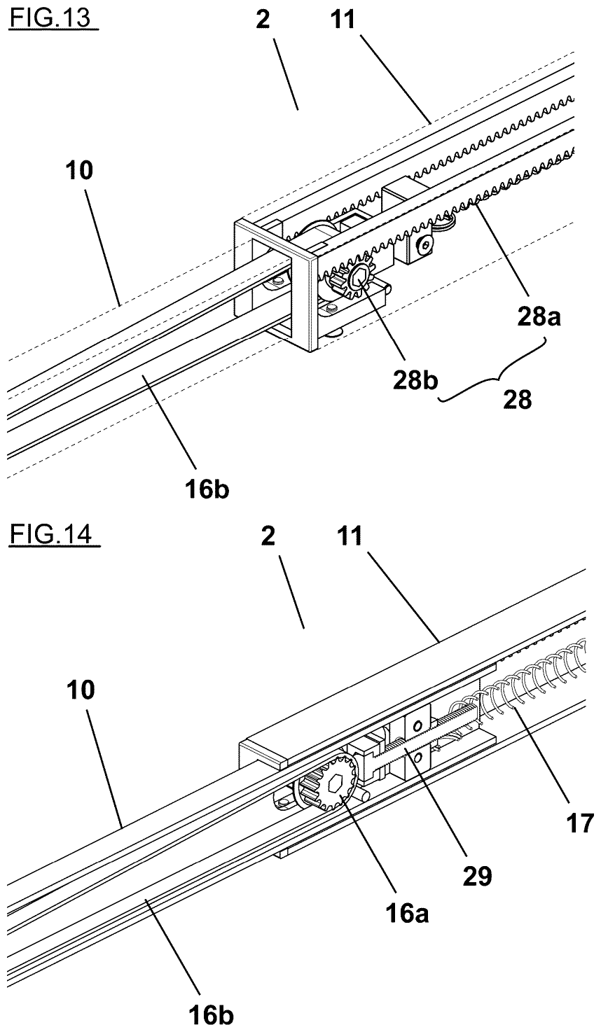

FIG. 13: A view of an embodiment of the telescoping mechanism in the handle,

FIG. 14: A sectional view of the representation from FIG. 13,

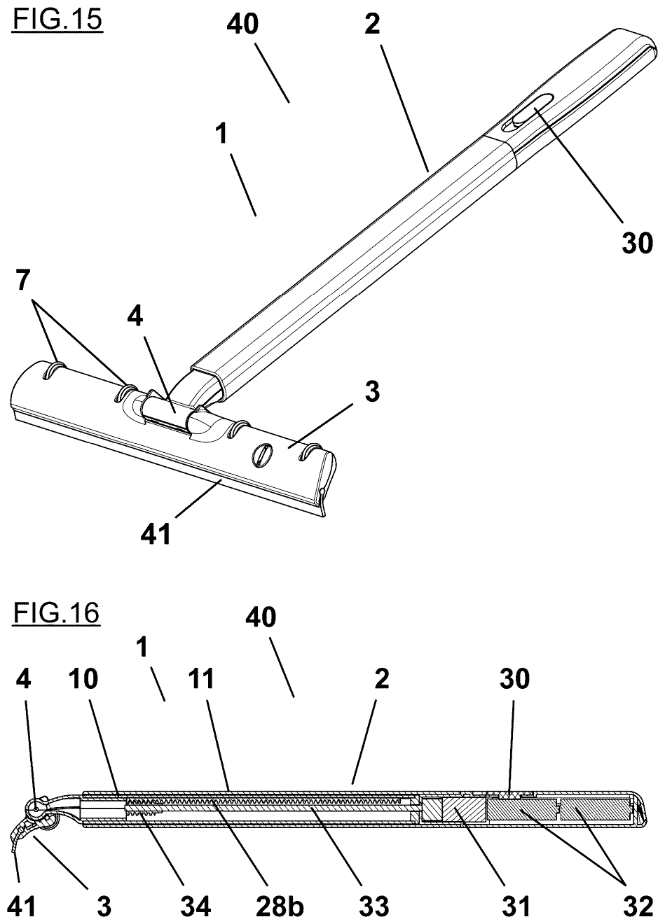

FIG. 15: A perspective view of a further embodiment of a squeegee with telescopic handle,

FIG. 16: A section through the embodiment shown in FIG. 15.

FIG. 1 shows a perspective view of an embodiment of a squeegee (40) according to the invention. The squeegee (40) has a body (1) according to the invention, which is composed of a handle (2) and a head section (3). The handle (2) and the head section (3) are connected to each other via a spring-loaded swivel joint (4), so that the angle between the handle (2) and the head section (3) can be varied.

A squeegee lip (41) is arranged on the head section (3) of the squeegee (40), which extends in a direction transverse to the handle (2). The squeegee lip (41) is fixed to the head section (3) by means of a detachable fixing element (42).

In other embodiments of the invention, several fixing elements (42) for fixing the squeegee lip (41) to the head section (3) are also conceivable. For example, two fixing elements (42) are conceivable, each of which fixes the squeegee lip (41) on one side.

A sliding or rolling device (7), which in the embodiment shown is realized by four parallel rollers, is arranged on the rear side of the head section (3) facing the handle (2).

In this embodiment, the external rolling surface of the rollers realizes the contact surface (8) of the sliding or rolling device (7).

The swivel joint (4) can be locked in a fixed position using a locking lever (9).

FIGS. 2A, 2B, 2C and 2D show a squeegee (40) according to the invention comprising a body (1) according to the invention next to a surface (50) to be squeegeed. With reference to these drawings, the functional principle of the body (1) according to the invention and the method according to the invention for squeegeeing or wiping are explained in more detail below.

As shown in FIG. 2A, the squeegee (40) is first placed with the head section (3) on the surface (50) to be squeegeed. The head section (3) is in the rest position. In embodiments of the invention, this is defined by the provision of a stop in the swivel joint (4).

The squeegee (40) then contacts the surface (50) to be squeegeed with the squeegee lip (41) and with the contact surfaces (8) of the sliding or rolling device (7) as shown in FIG. 2B.

These conditions should be complied to during the execution of the procedure for the best possible work result.

The spring-loading of the swivel joint (4) is designed in such a way that the squeegee lip (41) is pressed against the surface (50) to be squeegeed. This pressure is maintained regardless of the position of the handle (2) in relation to the head section (3) when the sliding or rolling device (7) contacts the surface (50) to be removed with the contact surfaces (8).

The position of the head section (3) in relation to the handle (2) is deflected from the rest position as required. This can be seen in FIGS. 2B to 2D.

The squeegee (40) is then guided with the contact surfaces (8) of the sliding or rolling device (7) along the surface (50) to be squeegeed in the working direction along the surface (50). The working direction is always aligned in the direction from the squeegee lip (41) to the sliding or rolling device (7), i.e. the sliding or rolling device (7) is in contact with the surface (50) to be squeegeed in front of the squeegee lip (41) in the wiping direction.

Despite the changing handle position, the squeegee lip (41) remains in the optimum position as long as the user keeps the rollers of the sliding or rolling device (7) in contact with the surface. These pressure rollers transfer the user's pressure force to the surface. Only the spring-loading of the swivel joint exerts an optimum force on the squeegee lip (41).

The direction of movement of the squeegee (40) in the working direction is uninhibited, as the squeegee lip (41) always tracks behind the rollers of the sliding or roller device (7) and is therefore always pulled, even if the user pushes the squeegee (40).

Preferably, a working direction from top to bottom is selected on the surface (50) to be squeegeed. However, it is also possible to work in horizontal paths.

It is particularly preferred that the surface (50) to be squeegeed is squeegeed in partially overlapping, approximately parallel strips.

If the orientation of the handle (2) is always kept with its rear side approximately towards a point at a comfortable height for a user in relation to the surface (50) to be squeegeed when performing the squeegeeing, the angle between the head section (3) and the handle (2) changes as the squeegee lip (41) moves over the surface (50) to be squeegeed. This makes it possible for a user to hold the squeegee (40) comfortably in any position of the squeegee (40) on the surface (50) to be removed.

If the head section (3) on the surface (50) to be squeegeed, as shown in FIG. 2C, is approximately at the height at which the handle (2) is held, the angle between the head section (3) and the handle (2) is approximately 90°.

In preferred embodiments of the method, the squeegee (40) is guided in an end region, at the end of which the surface (50) to be squeegeed meets a second surface (51) at an angle, with the contact surfaces (8) of the sliding or rolling device (7) along the surface (50) to be squeegeed until these also contact the second surface (51). Then, as shown in FIG. 2D, the squeegee (40) is moved away from the surface (50) to be squeegeed with the contact surfaces (8) of the sliding or rolling device (7) in contact with the second surface (51). In the process, the head section (3) folds back in the direction of the rest position due to the spring action of the swivel joint (4), with the squeegee lip (41) sliding along the surface (50) to be squeegeed in the end region.

This means that a complete strip of the surface (50) can be squeegeed cleanly in a single wipe. With conventional squeegees, it is usually necessary to perform a second wipe at right angles to the first wipe in order to completely squeegee the end area of the surface.

FIG. 3 shows a perspective view of an embodiment of a squeegee (40) according to the invention with a telescopic handle (2). The handle (2) has an inner tube (10) that can be inserted into and pulled out of an outer tube (11), so that the length of the handle (2) can be changed.

According to the invention, the telescoping capability of the handle (2) is realized by at least two tubes which can be displaced one inside the other. In embodiments of the invention, it is also possible to use three or more interlocking tubes to realize the telescoping function of the handle (2), so that a greater extension can be realized compared to only two tubes while maintaining the same handle length in the inserted state.

In embodiments of the invention, the length adjustment of the fully or partially telescoped handle (2) can be locked freely or in predetermined positions by means of a telescopic lock (14).

The squeegee according to FIG. 3 is shown in FIG. 4 with an open housing in the area of the head section and the inner tube (10) of the handle (2).

In the area of the head section (3), the spring-loading (5) of the swivel joint (4) can be seen, which is realized by two torsion springs arranged on the opposite sides of the axis of rotation (6) of the swivel joint (4).

The locking device of the swivel joint (4) is realized by a locking lever (9) and a locking hook (12). The locking lever (9) is arranged on the axis of rotation (6) of the swivel joint (4). If the locking lever (9) is switched to the locking position, the locking hook (12) engages in a groove in the body of the head section (3) and thereby locks the swivel joint (4).

In the shown embodiment of the invention, the four rollers of the sliding and rolling device (7) are mounted on a common axle, which is held in the rear area of the head section (3). However, embodiments in which not all rollers are mounted on a common axle are also conceivable. For example, each roller can also be rotatable on its own axle.

FIG. 5 illustrates the use of a squeegee (40) with a body (1) according to the invention for squeegeeing a surface (50), wherein the squeegee (41) has a swivel joint (4) and a telescopic handle (2). It can be seen that the surface (50) to be squeegeed can also be squeegeed in the lower area located below the center of the user's body in a comfortable posture for the user. Both the orientation of the hand holding the handle (2) and the body posture as such are ergonomic and comfortable for the user.

The working direction indicated by the arrow runs from top to bottom.

FIG. 6 shows a section through a perspective view of a body (1) according to the invention used for a squeegee (41).

The handle (2) of the body (1) can be automatically telescoped. A drive element (13), in this case designed as a roller (15) arranged on the head section (3), is connected to an extension and retraction element via a transmission device, in this case realized by a toothed pulley (16a) or a pinion, which is mounted on the axis of the drive element (15), and a belt (16b) or a chain. With the aid of these components, a rotary movement can be converted into a linear movement and used to move the inner tube (10) relative to the outer tube (11) of the telescopic handle (2).

To retract the telescopic handle (2) without a reverse drive of the drive element (15), which in the present case would correspond to an undesired movement of the squeegee (40) against the working direction, the handle (2) in the illustrated embodiment has a return spring (17), which is tensioned when the handle (2) is extended.

FIG. 7 shows a detailed view of a head section (3) of a body (1) for a squeegee (40) according to FIG. 6, also in a perspective top view.

The drive element (13) has two rollers (15), which are arranged centrally on the head section (3) in the area of the swivel joint (4) and which are each arranged to the side of a belt (16b).

The sliding and rolling device (7) comprises two additional rollers at the two lateral ends of the head section (3).

The drive of the telescopic handle (2) can be activated via at least one activation element, in this case designed as two activation sliders (22). If the at least one activation element is not activated, the movement of the drive element (13) is not used to telescope the handle (2).

When the activation element is activated, the at least one drive element (13) is coupled in the illustrated embodiment of the invention with the aid of two control cams (18), each of which is guided in a helical oblique slot (21). A first stop (19) defines the rest position into which the head section (3) moves without external action due to the suspension of the swivel joint (4). The first stop (19) serves to return the control cams (18) to the rest position when the head section (3) is returned to the rest position.

In addition, the housing of the head section (3) has a housing lock (23), via which the housing parts can be locked together in the correct position for assembly.

FIG. 8 shows the head section (3) of the body (1) as shown in FIG. 7 with the upper housing part removed. The suspension (5) of the swivel joint (4) can thus be seen.

FIG. 9 shows the head section (3) from FIG. 8 at a different angle of the handle (2) to the head section (3). The control cams (18) have rotated together with the handle (2).

FIG. 10 shows a detailed view of the head section (3) as shown in FIG. 9 in the area of a control cam (18).

In FIG. 11, the embodiment of the head section (3) of a body for a wiper or squeegee according to the invention as shown in FIGS. 6 to 10 is shown from the front with the handle (2) strongly deflected from the rest position. This alignment of the handle (2) to the head section (3) is realized in the end region of the surface (50) to be cleaned, which is located in the working direction.

In this illustration, the activation elements (24) are in the deactivated position, i.e. the activation sliders (22) are not shifted inwards towards the center of the head section (3). However, the stop shoulders (25) of the activation elements (24) are clearly visible in this illustration. If the activation elements (24) are activated by moving the activation sliders (22) inwards accordingly, the stop shoulders (25) lie in the movement paths of the control cams (18). When the handle (2) is deflected accordingly by turning the swivel joint (4), these cams strike against these stop shoulders (25) and cannot be turned any further as a result.

The positioning of the stop shoulders (25) in relation to the deflection angle of the control cams (18) is preferably realized in such a way that the stop of the control cams (18) on the stop shoulders (25) occurs at an angle of approximately 90° between the head section (3) and the handle (2). In this position, the transition from a pulling to a pushing movement takes place. If the working direction is vertical, this corresponds approximately to a horizontal alignment of the handle (2). As a result, the handle (2) automatically extends with increasing deflection when cleaning the surface, so that the end area of the surface can also be conveniently wiped or wiped.

As soon as the control cams (18) are attached to the stop shoulder (25) of the respective activation element (24), the control cams (18) are displaced in the respective slotted hole (21) when the swivel joint (4) is rotated further. The slotted holes (21) are arranged at an angle in the direction of the drive element (13), so that the control cams (18) are displaced in the direction of the drive element (13) when the swivel joint (4) is rotated further in the respective slotted hole (21).

The operation of the coupling device (26) realized in this way can be seen in FIG. 12. In the area of the right-hand roller (15), the figure is shown as a section. The control cams (18) are each connected to a connecting element (27), which can be displaced on the axis of a respective roller (15) of the drive element (13) by displacing the control cam (18) in the respective slotted hole (21). The displacement is transmitted to the respective roller (15). The slotted holes (21) are arranged in a part of the body (1) that is rigidly connected to the handle (2).

In the preferred embodiment shown, the connecting elements (27) are connected to the respective roller (15) so that the rotary movement of the roller (15) and connecting element (27) or control cam (18) are decoupled from each other.

If the connecting element (27) is now displaced in the direction of the roller (15) by turning the handle (2) relative to the head section (3) together with the control cam (18) resting against the stop shoulder (25), the latter is displaced on its axis of rotation in the direction of the belt (16b). In the process, force transmission elements of the coupling device (26) for transmitting the rotation from the roller (15) to the belt (16b) engage with one another, which are designed as detents in the present case. In this case, the coupling device (26) has detents firmly attached to the roller (15) and firmly attached to the toothed pulley (16a)—here located under the belt (16b) and therefore not visible.

If the roller (15) is displaced so that the coupling device (26) couples it to the toothed pulley (16a), the rotary movement of the roller (15) is transmitted to the toothed pulley (16a) and thus also to the belt (16b), so that the belt is driven.

Resetting or uncoupling takes place automatically when the squeegee (40) or wiper is removed from the wall.

The spring of the swivel joint (4) relaxes and returns the head section (3) to its original position.

The first stop (19) moves the connecting element (27) back via the displacement of the control cam (18) in the respective slot (21), thereby uncoupling it.

In the embodiment shown, the roller (15) is coupled to the roller (15) via an annular groove (35) in the body of the connecting element (27), in which the roller (15) engages, for example, with the aid of a snap connection or stud bolts. As a result, the respective roller (15) and the associated connecting element (27) can be rotated relative to each other about the axis of rotation and are coupled in the axial direction to transmit a linear movement.

FIGS. 13 and 14 show details of the conversion of the rotational movement transmitted to the belt (16b) into a linear movement for displacing the inner tube (10) relative to the outer tube (11) of an embodiment of the telescopic handle (2) of a body (1) for a squeegee (40) or wiper according to the invention.

In the outer tube (11), the transfer device (28) in the embodiment shown is realized by two racks (28a) and an associated gear wheel (28b) engaging in the teeth of the rack (28a), whereby the gear wheels (28b) can be driven with the aid of the belt (16b). The rotation causes the gear wheels (28b) to move along the gear racks (28a) so that the inner tube (10) is displaced relative to the outer tube (11).

The rotary movement is transmitted from the belt (16a) to the gear wheels (28b) via a toothed pulley (16a), which is connected to the gear wheels (28b) on a common axis.

Furthermore, a return spring (17) for retracting the inner tube (10) into the outer tube (11) and a belt tensioner (29) for tensioning the belt (16b) are arranged in the handle (2).

FIGS. 15 and 16 show an embodiment of a squeegee (40) with a body (1) according to the invention, which has a motor-driven, telescopic handle (2).

The motor (31) arranged in the handle (2) can be activated via a switch (30). Preferably, the switch (30) has at least three different positions via which the direction of rotation of the motor (31) for extending or retracting the handle (2) can be set or the motor (31) can be switched off.

In embodiments of the invention, the handle (2) can also be retracted by disengaging the motor (31) in the corresponding switch position, whereby the required restoring force is then preferably applied with the aid of a return spring.

In advantageous embodiments, the motor (31) is designed as an electric motor that can be supplied with energy with the aid of at least one energy storage device (32) arranged in the handle (2).

In the embodiment shown, the motor (31) has a drive shaft (33) coupled to the motor shaft, at whose end facing away from the motor (31) a drive worm (34) is arranged. This drive worm (34) engages in a rack (28b) connected to the inner tube (10), so that the inner tube (10) can be displaced relative to the outer tube (11) by rotation of the motor (31) to realize the telescopic function of the handle (2).

In other embodiments of the invention, the body (1) has at least one sensor for detecting the orientation of the handle (2) in relation to the head section (3), so that the telescoping of the handle (2) can be carried out automatically in a corresponding position range by a corresponding actuation of the motor (31).

For example, the angle between the handle and the head section is detected using a reed contact.

In embodiments, the telescoped handle (2) can be reset by an impulse from the reed contact, whereby the worm gear is disengaged and the telescope is pulled back into the shortened position by spring force or the motor switches in the opposite direction and pulls the telescopic rod back at increased speed.

1-14. (canceled)

15. A body for a squeegee or a wiper, comprising: a handle; a head section connected to the handle; a squeegee lip and/or a wiper bar; and a spring-loaded swivel jointed that connects the head section to the handle, the spring-loaded swivel joint having an axis of rotation aligned parallel to a longitudinal direction of the squeegee lip or of the wiper bar.

16. The body according to claim 15, wherein the spring-loaded swivel joint has an angle of rotation that is limited by at least one stop element.

17. The body according to claim 15, wherein the spring-loaded swivel joint includes a torsion spring.

18. The body according to claim 15, further comprising at least one sliding or rolling device for contacting a surface to be processed, the sliding or rolling device being arranged in front of the squeegee lip or the wiping bar in a working direction.

19. The body according to claim 18, wherein the handle is telescopic.

20. The body according to claim 19, further comprising a telescoping mechanism configured to couple the telescoping of the handle to alignment and/or movement of the body so that telescoping of the handle is implemented automatically, at least in certain areas, during use.

21. The body according to claim 20, further comprising at least one drive element coupled to the telescoping mechanism for telescoping the handle.

22. The body according to claim 21, wherein the at least one drive element is at least one roller of the sliding or rolling device.

23. The body according to claim 21, wherein the drive element is a motor.

24. The body according to claim 23, wherein the motor is automatically activatable when the head section is deflected relative to the handle at an angle of greater than or equal to approximately 90° as detected by at least one sensor.

25. A squeegee comprising a body according to claim 15.

26. A wiper comprising a body according to claim 15.

27. A method for squeegeeing a surface, comprising using a squeegee according to claim 25.

28. A method for wiping a surface, comprising using a wiper according to claim 26.

29. The method for squeegeeing a surface according to claim 27, including guiding the squeegee away from the surface to be squeegeed in an end region of the surface to be squeegeed, at the end of which end region the surface to be squeegeed meets a second surface at an angle, along the second surface after contacting the second surface.

30. The method for wiping a surface according to claim 28, including guiding the wiper away from the surface to be wiped in an end region of the surface to be wiped, at the end of which end region the surface to be wiped meets a second surface at an angle, along the second surface after contacting the second surface.
